(19) United States
(12) Patent Application Publication
(10) Pub. No.: US 2024/0276140 A1
(43) Pub. Date: Aug. 15, 2024

(54) LOUDSPEAKER MODULE WITH VIBRATION-DAMPING STRUCTURE

(71) Applicant: SABLE CORPORATION, New Taipei City (TW)

(72) Inventors: Kuang-Yun LI, New Taipei City (TW); Hui-Cheng CHEN, New Taipei City (TW)

(21) Appl. No.: 18/338,038

(22) Filed: Jun. 20, 2023

(30) Foreign Application Priority Data
Feb. 14, 2023 (TW) 112105146

(51) Int. Cl. H04R 1/28; H04R 1/02

(52) U.S. Cl. CPC H04R 1/288; H04R 1/021; H04R 2400/11

(57) ABSTRACT

A loudspeaker module with a vibration-damping structure includes a box, a speaker driver, a fixing frame, and a vibration-damping gasket, wherein the speaker driver, the fixing frame, and the vibration-damping gasket are all arranged in the box. The fixing frame is arranged around the speaker driver, and a fixing rib projects from the fixing frame. The vibration-damping gasket is arranged around the fixing frame, and one side of the vibration-damping gasket is provided with a groove for the fixing rib to be embedded into the groove. The loudspeaker module with a vibration-damping structure according to the invention is applied to notebook computers or other machines. The vibration-damping gasket absorbs the vibration energy of the speaker driver and reduces the transmission of resonance energy to the machine to avoid abnormal sounds caused by the resonance.

This application claims priority for TW Application No. 112105146 filed on Feb. 14, 2023, the contents of which is incorporated by reference in its entirely.

### BACKGROUND OF THE INVENTION

### Field of the Invention

The invention relates to the field of loudspeakers, in particular, to a loudspeaker module with a vibration-damping structure.

### Description of the Prior Art

The loudspeaker module is a speaker driver arranged in box, and when the speaker driver emits a sound, the frequency of the sound will make the loudspeaker module of the speaker driver vibrate. Therefore, when the loudspeaker module is fixed on the device (such as note computer, TV, screen, etc.), the vibration will be transmitted through the device to cause resonance with the device mechanism, which results in abnormal resonance sound and increases the difficulty in vibration prevention for the design of the mechanism; meanwhile, the derived noise also increases the distortion of the device, which makes the user feel uncomfortable.

In the prior art, a rubber is arranged at a screw hole between the box and the device (such as the notebook computer) to reduce the vibration of the box from being transmitted to the device through the screw hole. However, this practice cannot completely prevent the device from receiving vibration energy. How to design a vibration-damping structure on the module so as to absorb the vibration energy at the source, preventing the vibration energy from being transmitted to the device, is a subject to be solved.

In view of this, for the drawbacks of the above-mentioned conventional technology and the needs of the future, the invention provides a loudspeaker module with a vibration-damping structure, so as to solve the above drawbacks, wherein the specific architecture and the implementation will be described in detail below.

### SUMMARY OF THE INVENTION

The objective of the invention is to provide a loudspeaker module with a vibration-damping structure, which arranges a vibration-damping gasket around a speaker driver to absorb the vibration energy of the speaker driver for avoiding the vibration energy from being transmitted to the machine and producing abnormal sound.

To achieve the above objective, the invention provides a loudspeaker module with a vibration-damping structure, which includes a box, a speaker driver, a fixing frame, and a vibration-damping gasket, wherein the speaker driver is arranged in the box; the fixing frame is arranged around the speaker driver, and a fixing rib projects from the fixing frame. The vibration-damping gasket is arranged around the fixing frame, and one side of the vibration-damping gasket is provided with a groove for the fixing rib to be embedded into the groove.

According to an embodiment of the invention, the design is as follows: the box includes an upper case and a lower case, and the surface of the upper case is provided with an opening to set the speaker driver, and the box is used to isolate sound waves in front of and behind the speaker driver to prevent the sound waves from the front and rear of the speaker from interfering with each other speaker driver.

The vibration-damping gasket is sandwiched between the upper case and the lower case, and the speaker driver is suspended in the box.

The lower case is provided with a plurality of supporting members for supporting the vibration-damping gasket.

The supporting members are arranged in the annulus corresponding to the bottom surface of the vibration-damping gasket.

The vibration-damping gasket is integrally formed.

The vibration-damping gasket is C-shaped or square-shaped.

The vibration-damping gasket is solid or hollow.

### BRIEF DESCRIPTION OF THE DRAWINGS

FIG. 1 is a three-dimensional diagram of a first embodiment of a loudspeaker module with a vibration-damping structure according to the invention;

FIG. 2 is an exploded diagram of the first embodiment of the loudspeaker module with a vibration-damping structure according to the invention;

FIG. 3 is a side cross-sectional diagram of the first embodiment of the loudspeaker module with a vibration-damping structure according to the invention;

FIG. 4 is an exploded diagram of a second embodiment of the loudspeaker module with a vibration-damping structure according to the invention;

FIG. 5 is a side cross-sectional diagram of the second embodiment of the loudspeaker module with a vibration-damping structure according to the invention;

FIG. 6 is an exploded diagram of a third embodiment of the loudspeaker module with a vibration-damping structure according to the invention;

FIG. 7 is a side cross-sectional diagram of the third embodiment of the loudspeaker module with a vibration-damping structure according to the invention;

FIG. 8 is a diagram of a test in which three test points on the loudspeaker module with a vibration-damping structure are taken for the test according to the invention;

FIGS. 9 to 11 are acceleration experiment data diagrams for testing at three test points after simulating attaching a base and a gasket to the loudspeaker module with a vibration-damping structure locked in the notebook computer according to the invention;

FIGS. 12 to 14 are acceleration experiment data diagrams for testing at three test points after simulating only attaching the base to the loudspeaker module with a vibration-damping structure locked in the notebook computer according to the invention.

### DESCRIPTION OF THE PREFERRED EMBODIMENTS

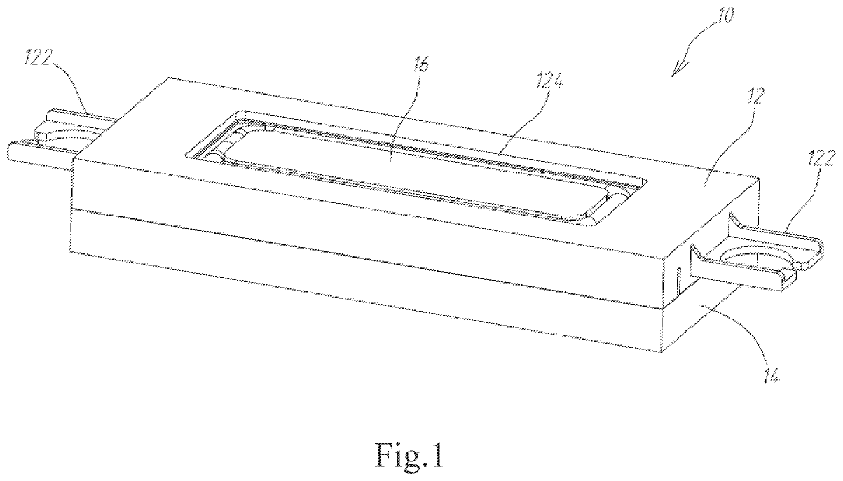

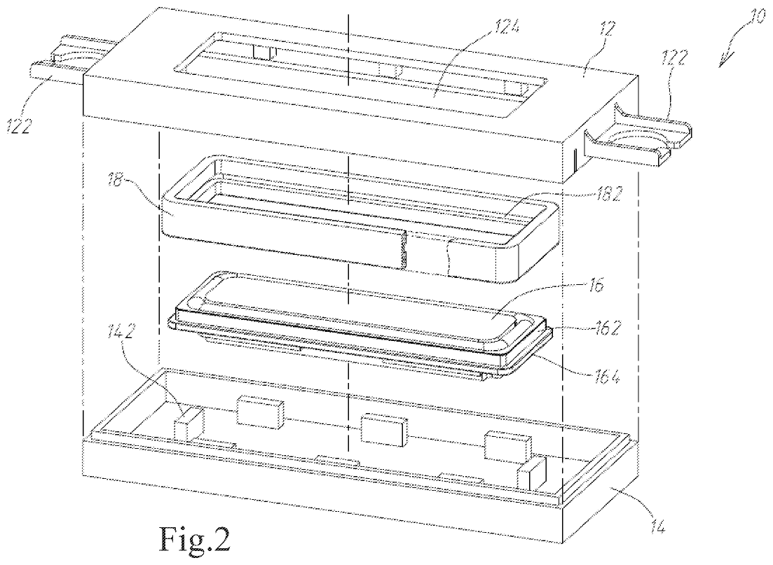

With reference to FIGS. 1 and 2 at the same time, a three dimensional diagram and an exploded diagram of the first embodiment of the loudspeaker module with a vibration-damping structure 10 according to the invention are respectively shown. The loudspeaker module with a vibration-damping structure 10 is applied to a notebook computer or other machines, and the loudspeaker module with a vibration-damping structure 10 includes a box, a speaker driver 16, a fixing frame 162, and a vibration-damping gasket 18, wherein the speaker driver 16, the fixing frame 162, and the vibration-damping gasket 18 are all arranged in the box. The box includes the upper case 12 and the lower case 14, both of which may be combined to form the box. An upper surface of the upper case 12 is provided with an opening 124 to set the speaker driver 16, and the box is used to isolate sound waves in front of and behind the speaker driver 16 to prevent the sound waves from the front and rear of the speaker from interfering with each other. Both sides of the upper case 12 are provided with a connecting portion 122, respectively; the connecting portion 122 is used to be connected with the mechanisms of the machine.

Since the speaker driver 16 vibrates when emitting the sound, vibration is transmitted to the machine through the connecting portion 122, causing the machine to emit abnormal sounds. Therefore, in the present invention, the vibration-damping gasket 18 is designed to be arranged around the speaker driver 16 to cover the speaker driver 16 from the sides. Further, a ring of fixing frame 162 is arranged around the speaker driver 16, which is an element that the speaker driver 16 originally has and is a support frame for the vibration system of the loudspeaker. In order to make the speaker driver 16 to be closely connected with the vibration-damping 18, a fixing rib 164 projects from the fixing frame 162, one side of the vibration-damp gasket 18 is provided with a groove 182, and the fixing rib 164 may be embedded into the groove 182. In this way, the vibration-damping gasket 18 is engaged with the fixing frame 162. In an embodiment, the fixing frame 162 is made of plastic, and the fixing rib 164 is made of rubber strips.

The fixing rib 164 is also arranged around the fixing frame 162, and the groove 182 is also arranged around the vibration-damping gasket 18. Compared with connecting by only a few points, the fixing rib 164 and the groove 182 are fitted together for a whole annulus, which may achieve the best fixing and vibration-damping effect.

In an embodiment, the vibration-damping gasket 18 is silica gel. The vibration-damping gasket 18 is formed integrally.

The lower case 14 is provided inside with a plurality of supporting members 142, arranged below the vibration-damping gasket 18 to support it. In an embodiment, the supporting members 142 are arranged in the annulus corresponding to the bottom surface of the vibration-damping gasket 18.

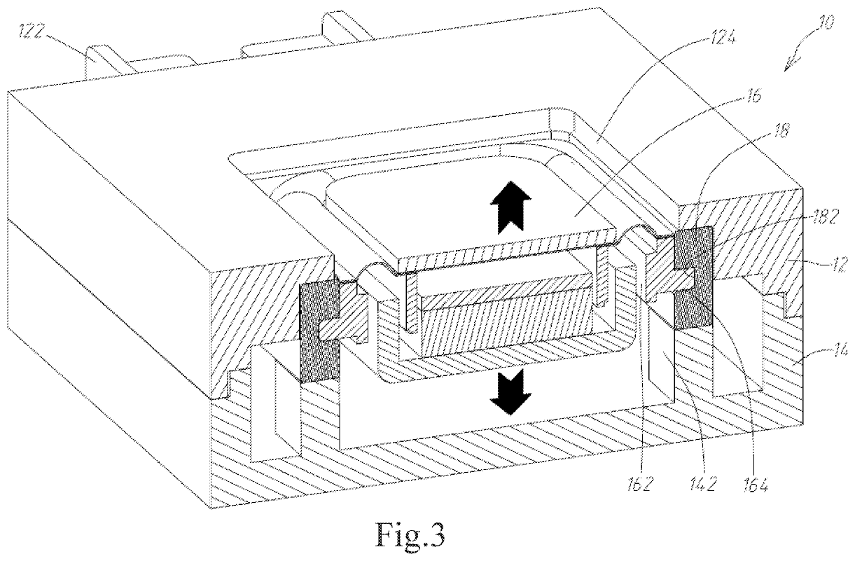

With reference to FIG. 3 at the same time, a side cross-sectional diagram of the first embodiment is shown. The diagram suggests that the vibration-damping gasket 18 is sandwiched between the upper case 12 and the lower case 14, with a lower part abutting against the supporting member 142. The groove 182 of the vibration-damping gasket 18 is engaged with the fixing rib 164 of the fixing frame 162. When the assembly is completed, the speaker driver 16 is suspended between the upper case 12 and the lower case 14, so that the speaker driver 16 vibrates up and down in the direction of the arrow when the speaker driver 16 emits the sound. Vibration energy will be absorbed by the vibration-damping gasket 18.

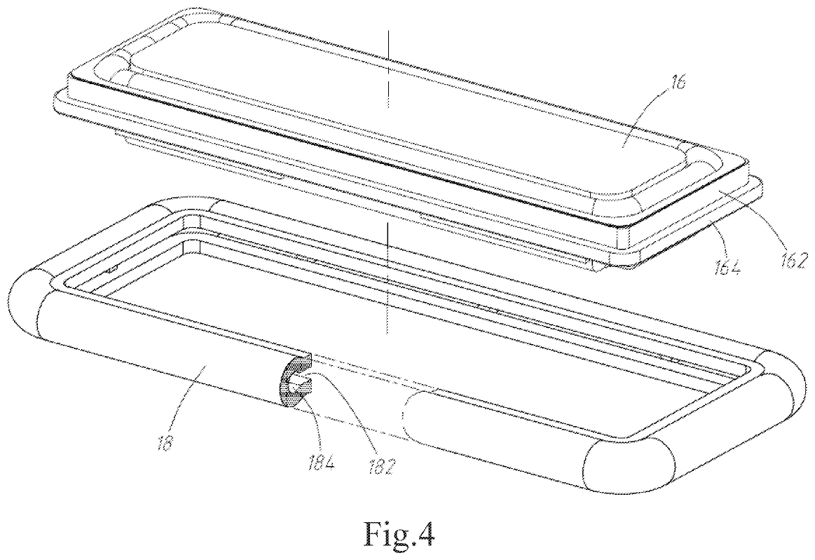

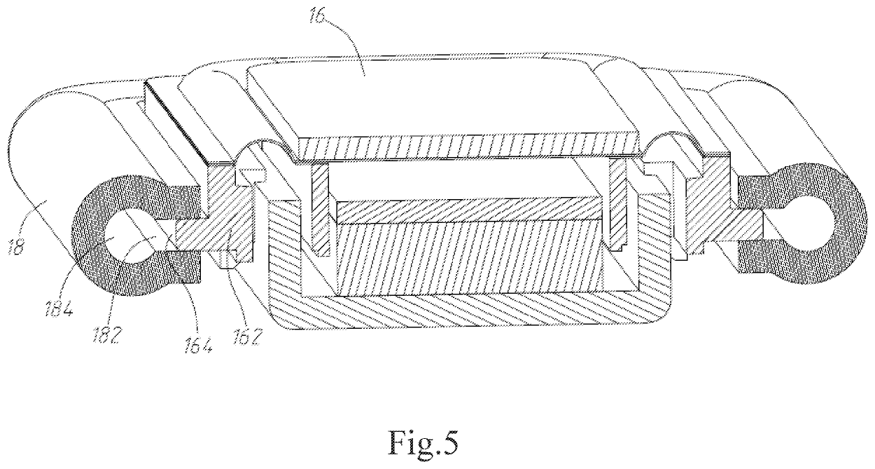

FIGS. 4 and 5 are an exploded diagram and a side cross-sectional diagram of a second embodiment of the loudspeaker module with a vibration-damping structure according to the invention. In the embodiment, the vibration-damping gasket 18 is C-shaped, hollow, and has an inner space 184. The inner space 184 is connected with the groove 182, but the fixing rib 164 of the fixing frame 162 is only embedded into the groove 182. The inner space 184 is obtained by forcibly demolding the vibration-damping gasket 18 during injection molding. The inner space 184 of the C-shaped vibration-damping gasket is in a circular shape.

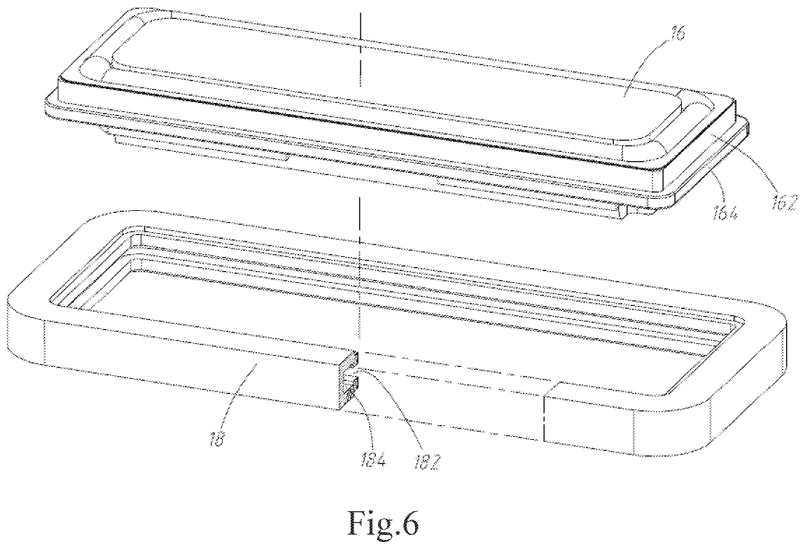

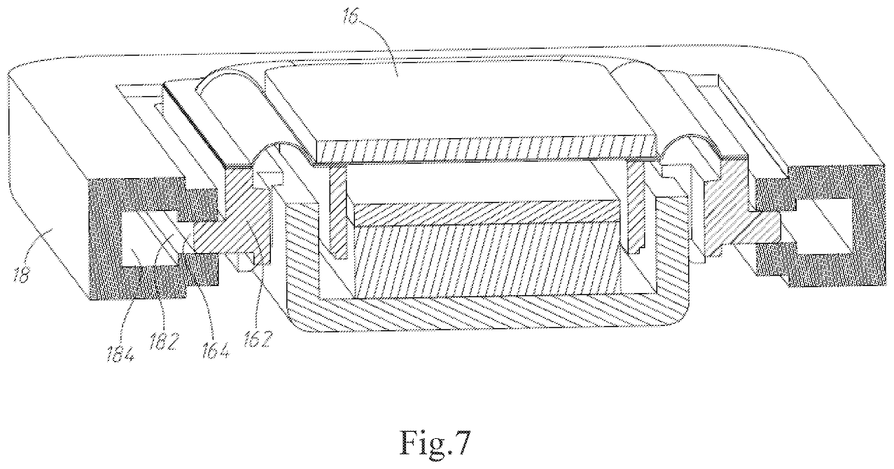

FIGS. 6 and 7 are an exploded diagram and a side cross-sectional diagram of a third embodiment of the loudspeaker module with a vibration-damping structure according to the invention. In the embodiment, the vibration-damping gasket 18 is square-shaped, hollow, and has an inner space 184. The inner space 184 is connected with the groove 182, but the fixing rib 164 of the fixing frame 162 is only embedded into the groove 182. The inner space 184 is obtained by forcibly demolding the vibration-damping gasket 18 during injection molding. The inner space 184 of the square vibration-damping gasket is square-shaped.

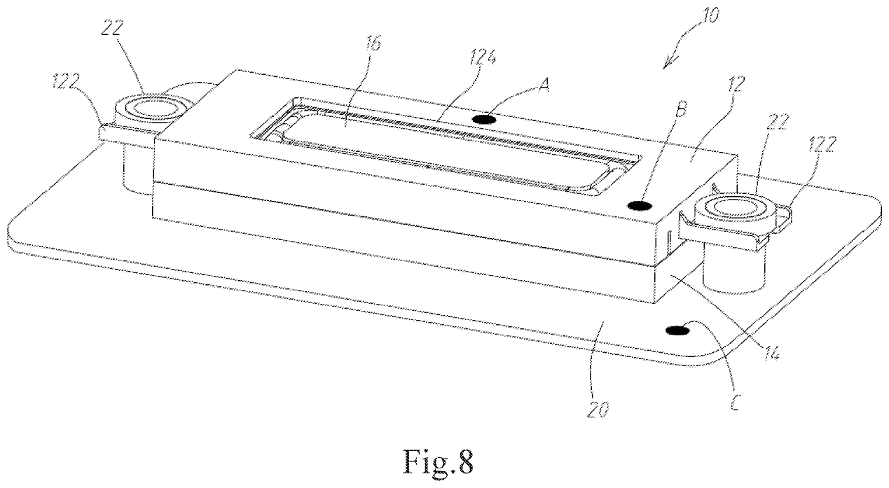

FIG. 8 is a diagram of a test in which three test points on the loudspeaker module with a vibration-damping structure 10 are taken for the test according to the invention. Before the experiment, first, the loudspeaker module with a vibration-damping structure 10 is mounted on a base 20, and a gasket 22 is placed on the connecting portion 122 on both sides. The gasket 22 is an element used for buffering and damping in the prior art. The three test points are two points A and B on the upper case 12 and one point C on the base 20 respectively.

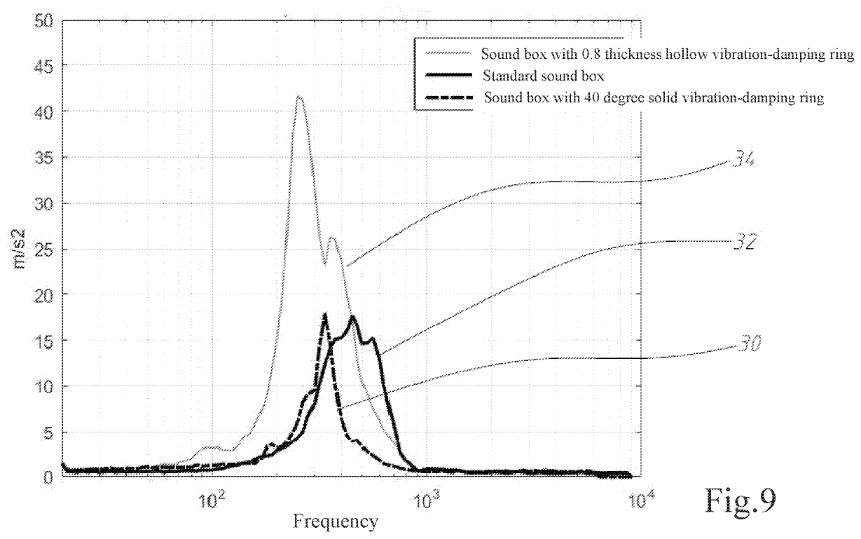

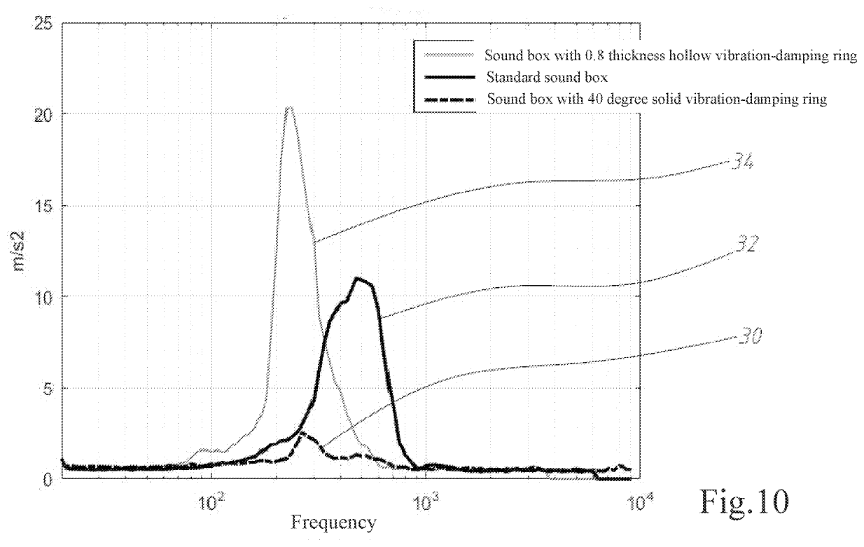

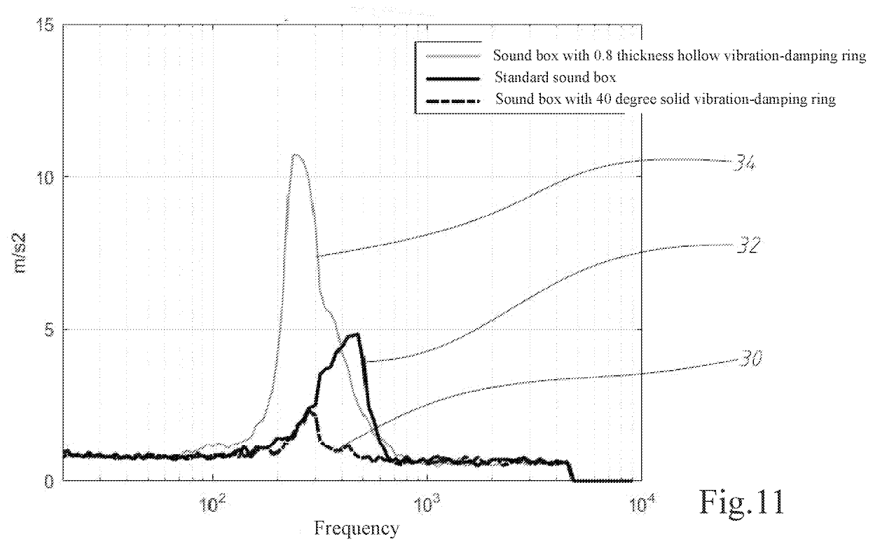

FIGS. 9 to 11 are vibration acceleration experiment data diagrams obtained by attaching the device in FIG. 8 to a notebook computer for simulation, wherein FIG. 9 corresponds to point A, FIG. 10 corresponds to point B, and FIG. 11 corresponds to point C. The experimental data includes a vibration acceleration curve 30 of a solid vibration-damping gasket of the first embodiment, a vibration acceleration curve 34 of a hollow vibration-damping gasket of the second embodiment, and a vibration acceleration curve 32 of a standard box (without the vibration-damping gasket). In the test results, regardless of the test points, the vibration acceleration measured by the hollow vibration-damping gasket is greater than or equal to the standard box, and the vibration acceleration measured by the solid vibration-damping gasket is smaller than the standard box. Obviously, the vibration-damping effect of applying a solid vibration-damping gasket is better.

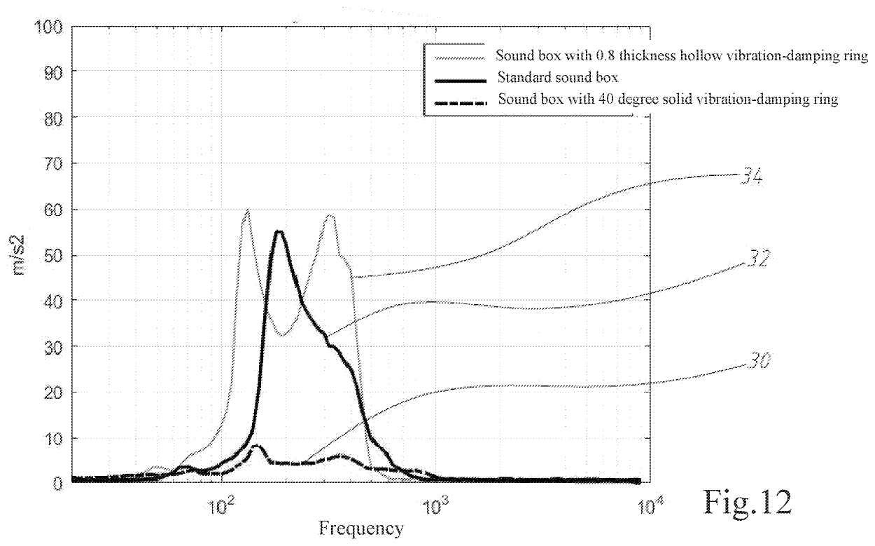

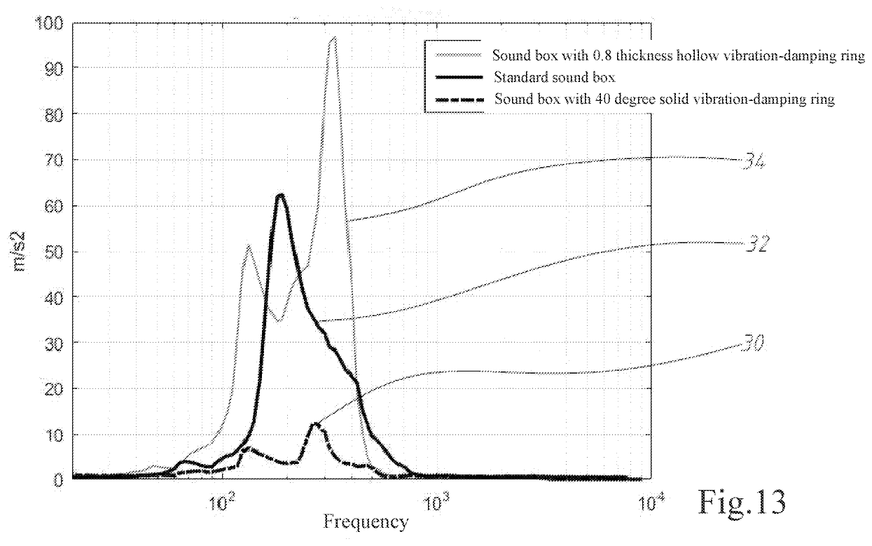

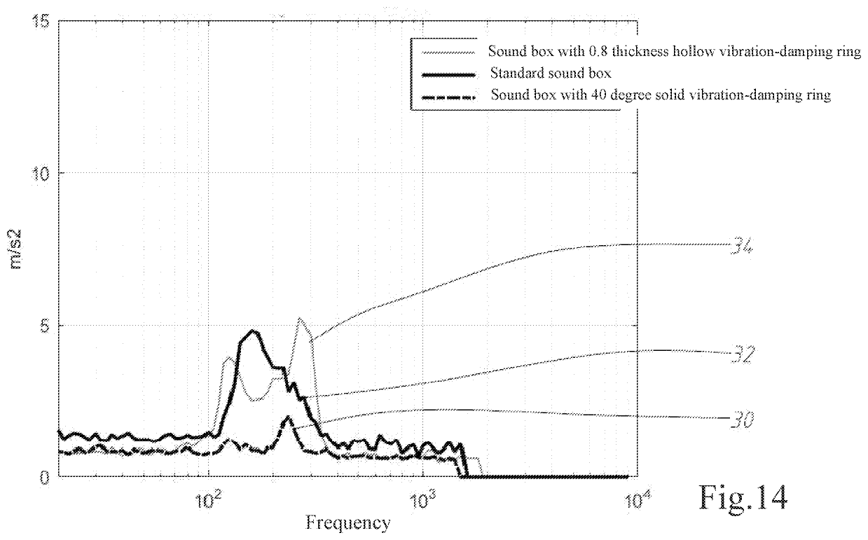

FIGS. 12 to 14 are vibration acceleration experiment data diagrams obtained by attaching the device in FIG. 8 to a notebook computer for simulation, wherein FIG. 12 corresponds to point A, FIG. 13 corresponds to point B, and FIG. 14 corresponds to point C. However, the gasket 22 is not placed on the connecting portion 122. The experimental data also includes a vibration acceleration curve 30 of a solid vibration-damping gasket of the first embodiment, a vibration acceleration curve 34 of a hollow vibration-damping gasket of the second embodiment, and a vibration acceleration curve 32 of a standard box (without the vibration-damping gasket). The diagrams show that regardless of the test points, the vibration acceleration measured by the hollow vibration-damping gasket is greater than the standard box, and the vibration acceleration measured by the solid vibration-damping gasket is smaller than the standard box. Therefore, obviously, the damping effect of the solid vibration-damping gasket is still better than that of the hollow vibration-damping gasket and the standard box. The difference in whether there is a gasket 22 or not is non-obvious.

In summary, for the loudspeaker module with a vibration-damping structure, by arranging the vibration-damping gasket around the speaker driver to absorb the vibration energy of the speaker driver when the loudspeaker emits the sound, the vibration energy produced is avoided from being transmitted to the machine to produce abnormal sounds through the screw hole.

The above-mentioned are only the preferred embodiments of the present invention and are not intended to limit the scope of the implementation of the present invention. Therefore, any equivalent changes or modifications made according to the features and spirit described within the scope of the present invention should be included within the claims of the present invention.

What is claimed is:

1. A loudspeaker module with a vibration-damping structure, the loudspeaker module comprises:
a box;
a speaker driver arranged in the box;
a fixing frame arranged around the speaker driver, a fixing rib projecting from the fixing frame; and
a vibration-damping gasket arranged around the fixing frame, one side of the vibration-damping gasket being provided with a groove for the fixing rib to be embedded into the groove.

2. The loudspeaker module with a vibration-damping structure according to claim 1, wherein the box comprises an upper case and a lower case.

3. The loudspeaker module with a vibration-damping structure according to claim 2, wherein a surface of the upper case is provided with an opening to set the speaker driver, and the box is used to isolate sound waves in front of and behind the speaker driver.

4. The loudspeaker module with a vibration-damping structure according to claim 2, wherein the vibration-damping gasket is sandwiched between the upper case and the lower case, and the speaker driver is suspended in the box.

5. The loudspeaker module with a vibration-damping structure according to claim 2, wherein the lower case is provided with a plurality of supporting members for supporting the vibration-damping gasket.

6. The loudspeaker module with a vibration-damping structure according to claim 5, wherein the plurality of supporting members is arranged in annulus corresponding to the vibration-damping gasket.

7. The loudspeaker module with a vibration-damping structure according to claim 1, wherein the vibration-damping gasket is integrally formed.

8. The loudspeaker module with a vibration-damping structure according to claim 1, wherein the vibration-damping gasket is C-shaped or square-shaped.

9. The loudspeaker module with a vibration-damping structure according to claim 1, wherein the vibration-damping gasket is solid or hollow.
